(19) United States
(12) Patent Application Publication
(10) Pub. No.: US 2007/0068618 A1
(43) Pub. Date: Mar. 29, 2007

(54) Splicing tapes with an alignment indicium

(75) Inventor: Scott J. Buchanan, Robbinsdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/235,745

(22) Filed: Sep. 27, 2005

(51) Int. Cl. B31F 5/00; B32B 37/12; B29C 65/00; B32B 7/12

(52) U.S. Cl. 156/157; 428/195.1; 156/304.3; 428/343

(57) ABSTRACT

Splicing tapes including an alignment indicium are provided. Methods of using such splicing tapes and webs spliced with such tapes are also described.

### FIELD OF THE INVENTION

The present invention relates generally to splicing tapes, more particularly to splicing tapes having an alignment indicium.

### SUMMARY

Briefly, in one aspect, the present invention provides a splicing tape including a backing, an adhesive adjacent a first major surface of the backing, and an alignment indicium visible from the second major surface of the backing. The major axis of the alignment indicium is parallel to the centerline of the tape. In some embodiments, the alignment indicium may be adjacent the second major surface of the backing, interposed between the first major surface of the backing and the adhesive, or adjacent the surface of the adhesive opposite the first major surface of the backing.

In some embodiments, the alignment indicium comprises a first line, which may be continuous or discontinuous. In some embodiments, the first line is parallel to and substantially aligned with, or offset from the centerline of the tape. In some embodiments, the alignment indicium comprises a second line, which may also be parallel to the centerline of the tape.

In some embodiments, the first line is an undulating line, e.g., a sinusoidal line or a saw-toothed line wherein the major axis of this undulating line is parallel to the centerline of the tape. In some embodiments, a line tangent to the peaks of the undulating line and/or a line tangent to the valleys of the undulating line are parallel to the centerline of the tape.

In another aspect, the present invention provides a method of splicing two web ends. In some embodiments, the method includes placing a first end of a first web in alignment with a second end of a second web forming a splice boundary having a splice major axis. The major axis of the alignment indicium of a splicing tape of the present invention is aligned with the splice major axis, and the splicing tape is adhered to the first end of the first web and the second end of the second web. In some embodiments, the first web and the second web are the same web, i.e., the first end and the second end are two ends of the same web.

In some embodiments, aligning the alignment indicium with the splice major axis includes substantially overlapping the splice major axis with the major axis of the alignment indicium. In some embodiments, aligning the alignment indicium with the splice major axis includes substantially aligning at least a portion of the alignment indicium with the peaks and/or valleys of an undulating splice boundary.

The above summary of the present invention is not intended to describe each embodiment of the present invention. The details of one or more embodiments of the invention are also set forth in the description below. Other features, objects, and advantages of the invention will be apparent from the description and from the claims. The recitation of numerical ranges by endpoints includes all numbers subsumed with that range (e.g., 1 to 5 includes 1, 1.5, 2, 2.75, 3, 4, 4.80, and 5).

### BRIEF DESCRIPTION OF THE DRAWINGS

FIG. 1A is a perspective view of a splice connecting the ends of two webs.

FIG. 1B is a perspective view of a splice connecting two ends of a single web.

FIG. 2 is a perspective view of a splicing tape according to some embodiments of the present invention.

FIG. 3A is a top view of a splicing tape according to some embodiments of the present invention, having an alignment indicium comprising a continuous straight line.

FIG. 3B is a top view of a splicing tape according to some embodiments of the present invention, having an alignment indicium comprising a discontinuous straight line.

FIG. 3C is a top view of a splicing tape according to some embodiments of the present invention, having an alignment indicium comprising a linear array of symbols.

FIG. 4A is a top view of a splicing tape according to some embodiments of the present invention, having an alignment indicium comprising a sinusoidal line.

FIG. 4B is a top view of a splicing tape according to some embodiments of the present invention, having an alignment indicium comprising a saw-toothed line.

FIG. 5 is a top view of a splicing tape according to some embodiments of the present invention, having an alignment indicium comprising a continuous straight line and a discontinuous straight line.

FIG. 6A is a perspective view of an exemplary splicing tape of the present invention aligned with the splice boundary formed by two web ends.

FIG. 6B is a perspective view of the splicing tape of FIG. 6A applied to the splice boundary.

FIG. 7 is a perspective view of a second exemplary splicing tape of the present invention aligned with the splice boundary formed by two web ends.

FIG. 8 is a perspective view of a third exemplary splicing tape of the present invention aligned with the splice boundary formed by two web ends.

FIG. 9A is a top view of an exemplary splicing tape of some embodiments of the present invention, wherein the tape comprises aligned fibers.

FIG. 9B is a perspective view of the alignment of the splicing tape of FIG. 9A with a splice boundary formed by two web ends.

### DETAILED DESCRIPTION

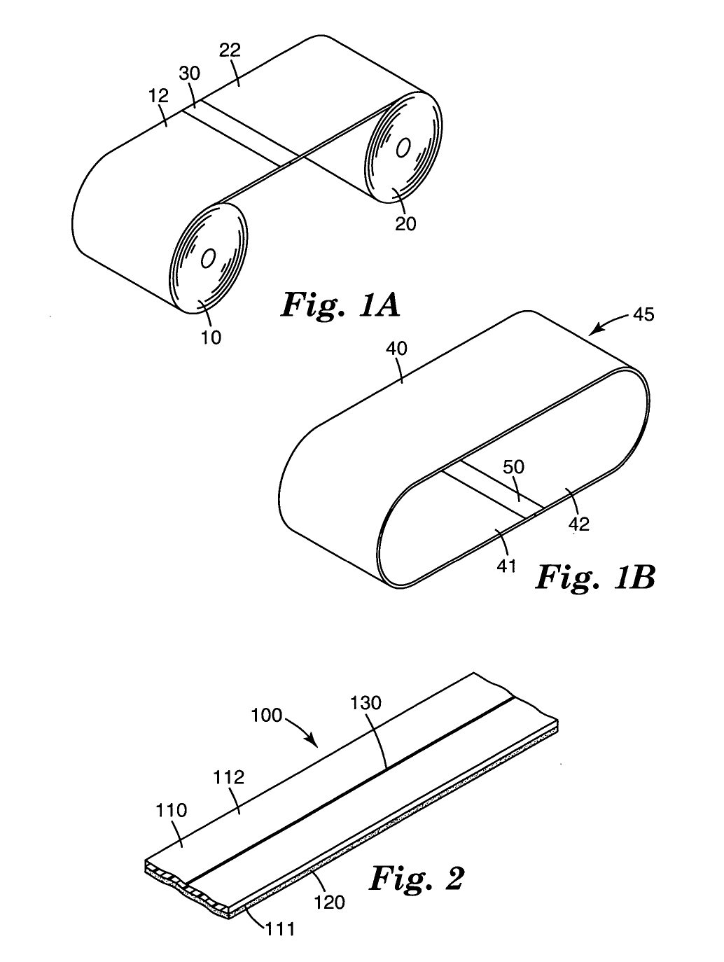

Generally, splicing tapes are used for various purposes in a wide variety of industries. For example, referring to FIG. 1A, end 12 of first web 10 is connected to end 22 of second web 20 via splicing tape 30. Alternatively, referring to FIG. 1B, first end 41 and second end 42 of web 40 are connected to each other via splicing tape 50, forming endless belt 45.

Exemplary web materials include paper, films (e.g., polymeric films), woven and non-woven webs, foils, and abrasive articles. Typical abrasive articles comprise abrasive particles adhered by a binder to a substrate. Generally, the material of the first web and the material of the second web may be independently selected. For example, an inexpensive material may be used to thread and/or start-up a piece of production equipment, before splicing in a second, more expensive, web material.

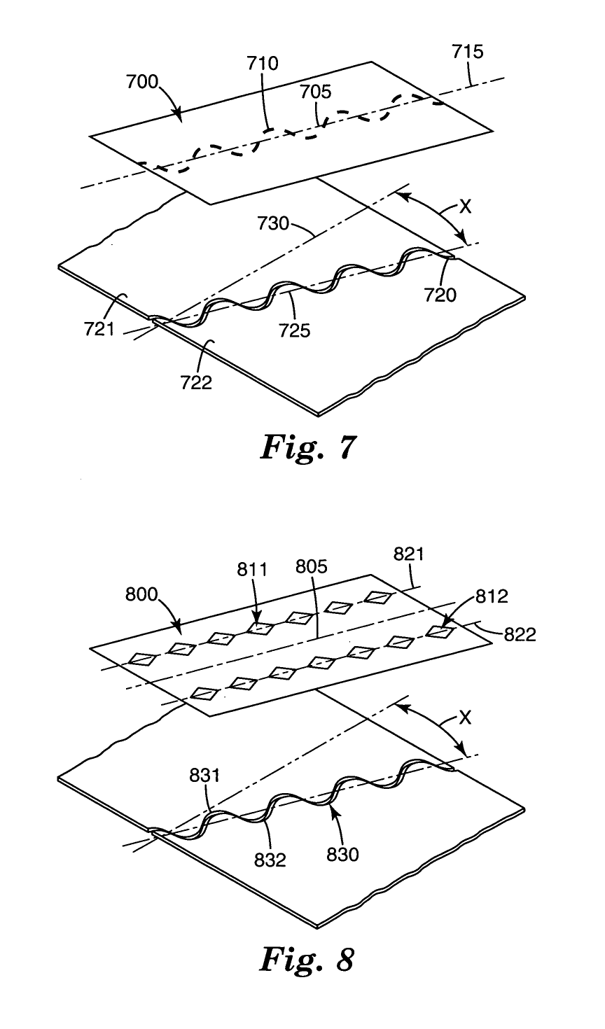

Generally, the splice boundary, i.e., the region where the first web end meets the second web end, may be visible through the splicing tape or may be obscured by the splicing tape. The splice boundary may be of any desired configuration, e.g., a straight line (see, e.g., FIG. 6A) or an oscillating line, e.g., a sinusoidal line (see, e.g., FIG. 7).

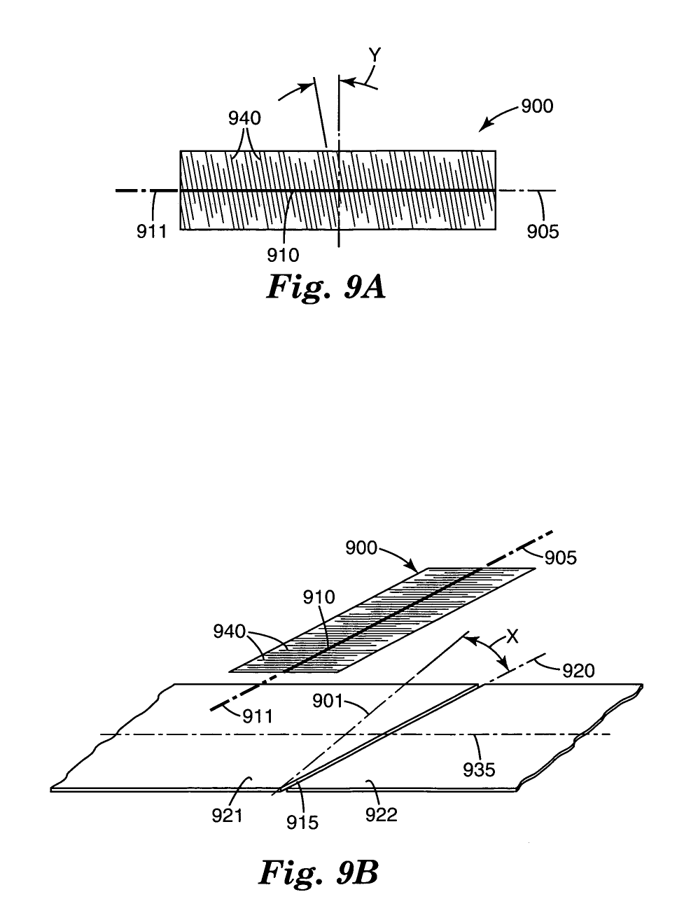

The major axis of the splice boundary may take on any orientation relative to the centerline of the web. As used herein, the “centerline” of a web or tape refers to a line extending along the longitudinal dimension of the web or tape, located at the center of the width of the web or tape. Referring to FIG. 6A, major axis 625 of splice boundary 620 is perpendicular to web centerline 655. Referring to FIG. 9B, major axis 920 of splice boundary 915 forms an angle X relative to reference line 901, which is perpendicular to web centerline 935. Generally, angle X can be any value from zero (i.e., perpendicular to the web centerline) to less than 90°. In some embodiments, angle X is greater than 30°; in some embodiments, greater than 45°, or even greater than 60°. In some embodiments, angle X is less than 89°; in some embodiments, less than 85°; in some embodiments, less than 80°, or even less than 75°.

Regardless of the application, certain performance characteristics are generally desired. For example, the splicing tape should exhibit a tensile strength sufficient to withstand the forces generated in the end use application. Splices should be resistant to heat generated during web transport and sufficiently flexible to accommodate repeated directional changes during web transport. Splices should be of a sufficiently low profile (in the web thickness dimension) to avoid unacceptable levels of bumping or “chatter” when spliced areas encounter a contact surface.

In some embodiments, the splice is balanced such that there is equal shear strength between the overlapping splicing tape and each of the two joined web ends. As used herein, a splice is “balanced” when the bonded area between the splice tape and the first web end multiplied by the adhesive force between the splice tape adhesive and the first web is approximately equal to the bonded area between the splice tape and the second web end multiplied by the adhesive force between the splice tape adhesive and the second web. For example, a splice connecting the ends of two similar (e.g., identical) webs with a uniformly applied splicing tape would be “balanced” when the area of the splice tape is divided equally between the two materials.

Generally, a wide variety of splicing tapes are available. One of ordinary skill in the art can readily select a particular splicing tape. Typically, splice tape selection will be based on the web materials to be spliced and the operating parameters, e.g., the tensile and shear forces, that the splice must endure. Additional factors that may affect selection of a splicing tape include tape dimensions (e.g., thickness and width), tape mechanical properties (e.g., tensile strength, elastic modulus, and conformability), compatibility with the web(s) being spliced and/or later processing steps (e.g., repulpability), appearance (e.g., color), and cost.

Generally, a splicing tape comprises a backing and an adhesive. Additional functional layers such as primers and reinforcement webs may be present as well. In some embodiments, reinforcing fibers may be present in one or more layers of the splicing tape.

Generally, any known backing may be used. Exemplary backings include polymeric films (e.g., polyester, polyolefin, and polycarbonate films), fabrics, metal foils, woven and nonwoven webs, and combinations thereof. Particular selection is within the skill in the art.

Generally, any known adhesive may be used. Useful adhesives include, e.g., pressure sensitive adhesives, hot melt adhesives, thermosetting adhesives, and glue. Exemplary adhesives include polyurethane adhesives, e.g., linear polyester urethanes that may be cured with, e.g., an isocyanate curing agent. Suitable pressure sensitive adhesives include a wide variety of pressure sensitive adhesives including, e.g., natural rubber-based adhesives, (meth)acrylate polymers and copolymers, AB or ABA block copolymers of thermoplastic rubbers, e.g., styrene/butadiene or styrene/isoprene block copolymers available as KRATON (Shell Chemical Co., Houston, Tex.), or polyolefins. Suitable hot melt adhesives include, e.g., polyester, ethylene vinyl acetate (EVA), polyamides, epoxies, and combinations thereof. Suitable thermosetting adhesives include, e.g., polyurethanes and nylon/epoxy resin mixtures. In some embodiments, the adhesive has sufficient cohesive strength and peel resistance to maintain the components in fixed relation to each other during use, and is resistant to chemical degradation under conditions of use. Particular selection is within the skill in the art.

In some embodiments, the splicing tape is transparent. As used herein, a splicing tape is “transparent” if the splice boundary is visible through the splicing tape. Thus, transparent splicing tapes of some embodiments of the present invention may include one or more translucent layers and/or one or more layers (e.g., scrims) that obscure a portion of the splice boundary when viewed through the splicing tape, so long as at least a portion of the splice boundary is discernable through at least a portion of the splicing tape.

The splicing tapes of the present invention include an alignment indicium. Referring to FIG. 2, exemplary splicing tape 100 includes backing 110 having first major surface 111 and second major surface 112. Adhesive 120 is adjacent first major surface 111, while alignment indicium 130 is visible from second major surface 112. In some embodiments, the adhesive is in direct contact with the first major surface of the backing. In some embodiments, an additional layer, e.g., a primer layer or a reinforcing layer, may be interposed between the adhesive and the first major surface of the backing.

As shown in FIG. 2, in some embodiments, the alignment indicium is located adjacent second major surface 112 of backing 110. In some embodiments, the alignment indicium is in direct contact with the second major surface of the backing. For example, in some embodiments, the alignment indicium may comprise an image, e.g., a line, printed on the first major surface. In some embodiments, an additional layer, e.g., a primer layer, a hard coat, a top coat, or a print receptive layer, may be interposed between the alignment indicium and the second major surface of the backing.

In some embodiments, the alignment indicium may be embedded within the backing. For example, in some embodiments, a thread or wire may be located partially or completely within the backing. In some embodiments, the embedded alignment indicium may comprise a colorant, e.g., a dye or pigment. In some embodiments, the alignment indicium may comprise a polymer, a metal, inorganic fiber(s), or organic fiber(s).

In some embodiments, the alignment indicium may be printed on a surface of, or embedded in an optional layer (e.g., primer layers, print receptive layers) located adjacent the first or second major surface of the backing. In some embodiments, the alignment indicium is located between the first major surface of backing and the adhesive. For example, the alignment indicium may be printed on the first major surface of the backing or on the surface of the adhesive adjacent the first major surface of the backing. In some embodiments, the alignment indicium may be printed on or embedded in an optional layer positioned between the first major surface of the backing and the adhesive, e.g., a primer layer. In some embodiments, the alignment indicium may be embedded in the adhesive or located adjacent the surface of the adhesive opposite the first major surface of the backing.

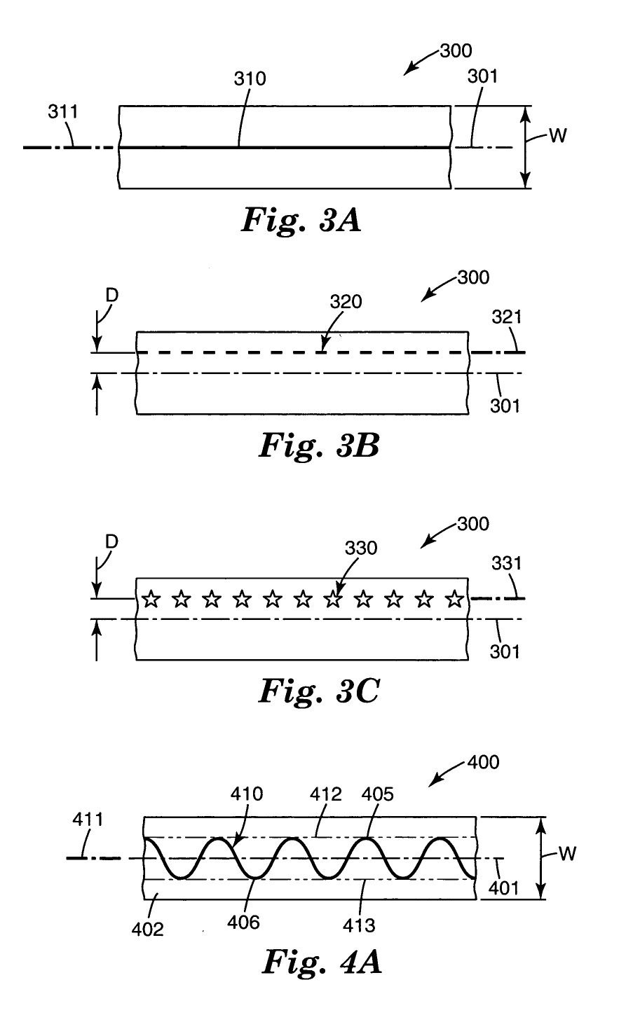

Referring to FIGS. 3A-3C, in some embodiments, the alignment indicium may comprise, e.g., continuous straight line 310, discontinuous straight line 320, or linear array of symbols (e.g., logos) 330. Referring to FIG. 3A, major axis 311 of the alignment indicium, i.e., continuous straight line 310, is parallel to and substantially aligned with centerline 301 of tape 300, i.e., the line extending in the longitudinal dimension of tape 300, located at the center of width W of tape 300. In some embodiments, the alignment indicium may be parallel to, but offset from the centerline of the tape. For example, referring to FIG. 3B, major axis 321 of discontinuous line 320 is parallel to centerline 301 of tape 300. However, major axis 321 of discontinuous line 320 is offset from centerline 301 by distance D. Similarly, referring to FIG. 3C, major axis 331 of linear array of symbols 330 is offset from centerline 301 of tape 300 by distance D.

Generally, distance D may be any value between zero and less than one-half W. In some embodiments, D is approximately one-quarter W, so that about one-fourth of the width of the splicing tape lies on one side of the major axis of the alignment indicium and about three-fourths of the width of the splicing tape lies on the other side of the major axis of the alignment indicium. In some embodiments, D is approximately one-sixth of W, so that about one-third of the width of the splicing tape lies on one side of the major axis alignment indicium and about two-thirds of the width of the splicing tape lies on the other side of the major axis of the alignment indicium.

If the alignment indicium comprises an array of symbols, it is generally desirable that the symbols be closely spaced such that the centerline of the array of symbols is easily identified. The centerline of an array of symbols is a line passing through the geometric center of each of the symbols. In some embodiments, the array of symbols is a linear array, i.e., the centerline of an array of symbols is a straight line. In some embodiments, the centerline of an array of symbols is an undulating line. In some embodiments, the gap between adjacent symbols is less than about 25 millimeters; in some embodiments, less than about 10 millimeters; in some embodiments less than about 5 millimeters, or even less than about 3 millimeters.

In some embodiments, the symbols are simple geometric shapes, e.g., squares, triangles, diamonds, stars, circles, polygons, and the like, such that a person applying the splicing tape may readily identify the geometric center of the symbols and, thus, the centerline of the array of symbols. As used herein, the term “geometric shapes” excludes complex images and text that have no readily discernable geometric center.

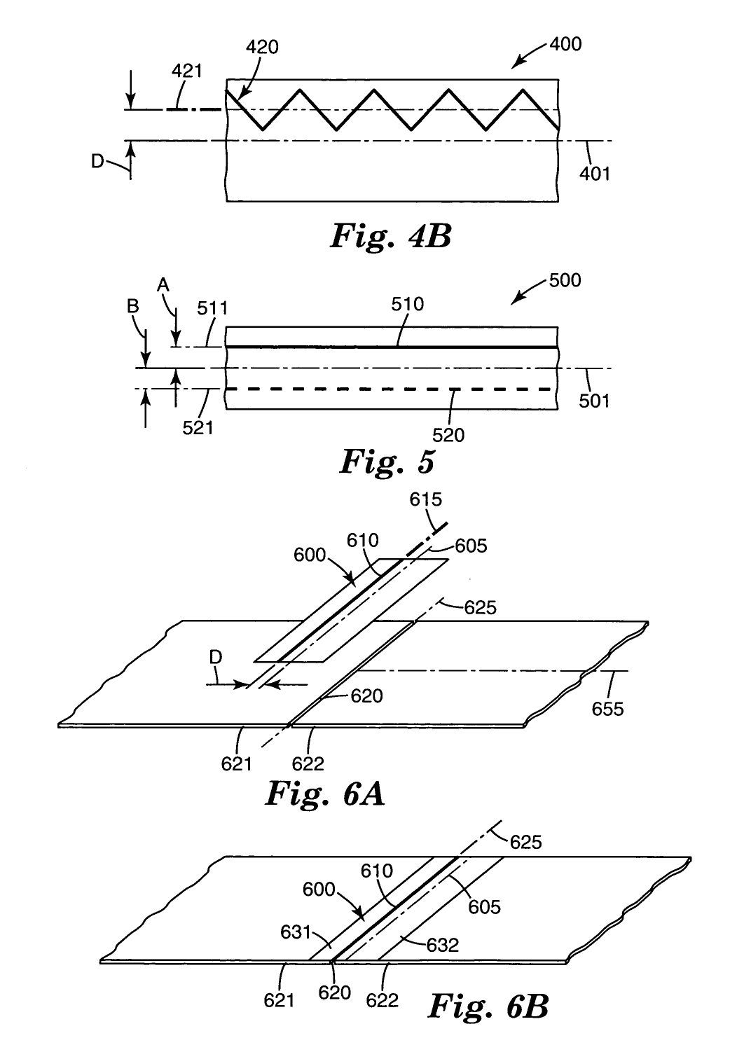

In some embodiments, the alignment indicium may comprise an undulating line. Referring to FIG. 4A, the alignment indicium comprises sinusoidal line 410. Major axis 411 of this alignment indicium is parallel to centerline 401 of splicing tape 400. In some embodiments, line 412, tangent to peaks 405 of sinusoidal line 410, is parallel to centerline 401 of splicing tape 400. Similarly, in some embodiments, line 413, tangent to valleys 406, is parallel to centerline 401. In some embodiments, major axis 411, line 412, and/or line 413 are imaginary lines. In some embodiments, major axis 411, line 412, and/or line 413 are visible from second major surface 402 of splicing tape 400.

Referring to FIG. 4B, in some embodiments, the undulating alignment indicium may be a saw-tooth line such as exemplary saw-tooth line 420. Major axis 421 of this alignment indicium is substantially parallel to and offset from centerline 401 of splicing tape 400, by distance D.

In some embodiments, the alignment indicium may comprise two or more lines or arrays of symbols, e.g., linear arrays of symbols. The lines may be, independently, linear or undulating, continuous or discontinuous. In some embodiments, it may be desirable to select the alignment indicium such that the individual components of the indicium may be distinguished from each other. For example, in some embodiments, it may be desirable to select an alignment indicium comprising at least two of a continuous line, a discontinuous line, and an array of symbols. In some embodiments, it may be desirable to select two or more lines and/or arrays of symbols differing in some feature such as color, thickness, or pattern (e.g., a first discontinuous line comprising a series of dashes and a second discontinuous line comprising a series of dots).

Referring to FIG. 5, the alignment indicium comprises continuous line 510 and discontinuous line 520. Major axis 511 of continuous line 510 and major axis 521 of discontinuous line 520 are substantially parallel to centerline 501 of splicing tape 500. Major axis 511 of continuous line 510 is offset from centerline 501 by distance A. Similarly, major axis 521 of discontinuous line 520 is offset from centerline 501 by distance B. Generally, distances A and B may be independently selected. In some embodiments, distance A is substantially equal to distance B.

In some embodiments, one or more lines and/or arrays of symbols composing the alignment indicium may be on the opposite side of the centerline of the tape from another line and/or array of symbols. For example, referring to FIG. 5, continuous line 510 and discontinuous line 520 are on opposite sides of tape centerline 501. In some embodiments, one or more lines or arrays of symbols composing an alignment indicium may be on the same side of the centerline of the tape as another line and/or array of symbols.

The alignment indicium may be formed by any known means. For example, in some embodiments, the alignment indicium maybe printed on one of the surfaces of the backing, the adhesive, or any optional layer included within the splicing tape. Both conventional (e.g., flexographic, rotogravure, letterpress) and digital (e.g., inkjet, thermal transfer) printing may be used. In some embodiments, the alignment indicium may comprise an unprinted region. For example, one surface of the backing may be flood coated with the exception of the region defining the alignment indicium.

In some embodiments, coatings may be applied to one or more surfaces of any layer present in the splicing tape, wherein the coating(s) alters at least one optical property (e.g., reflectance, transmission, translucence). The coatings may be applied such that alignment indicium is defined by a variation in one or more of such optical properties.

Generally, the alignment indicium will be visible under typical lighting conditions. However, in some embodiments, the inks or coatings used to create the alignment indicia may be visible when exposed to, e.g., ultraviolet or infrared light.

In some embodiments, the alignment indicium may comprise a separate element, e.g., a thread, positioned on or between one or more layers of the splicing tape. In some embodiments, such an element may be embedded within one or more layers. For example, a wire or thread may be embedded in the adhesive, or adhered between the backing and the adhesive layer.

In some embodiments, the alignment indicium may be formed by mechanically altering one or more layers of the splicing tape. For example, the backing, the adhesive, or one or more other optional layers may be scored, scratched, or embossed.

Generally, the splicing tapes of the present invention can be used in any application where typical splicing tapes are used, e.g., in bonding the end of one web (e.g., roll) of material to the end of a second end (e.g., roll) of material, or to bond two ends of the same web to each other to form, e.g., a continuous belt. Typically, the ends of the web to be bonded are prepared by cutting them in a pre-determined pattern. For example, the pattern may be a straight line either perpendicular to the length of the web, or at some angle relative to this perpendicular direction. Alternatively, the ends of the web may be cut in undulating patterns such that the peaks of one web end interlock with the valleys of the other web end. Again, the major axis of an undulating splice boundary may be perpendicular to the length of the web, or at some angle relative to this perpendicular direction.

Generally, as a spliced web is conducted through various operations, the splice will be subjected to a variety of forces that can lead to failure. In some operations, the webs will be subjected to tensile forces, which tend to pull the spliced ends of the web apart. These tensile forces create shear forces at the interface between each web end and the adhesive of the splicing tape, and tensile forces in the backing and other layers of the splicing tape as well.

For any particular application, there is some minimum shear force that the splice must withstand. Generally, the ability of a splicing tape to resist shear failure is a function of both the bonded area (i.e., the area of the web covered by the splicing tape) and the adhesion force between the adhesive and the web. Proper alignment of a splicing tape relative to a splice boundary can help ensure that the desired bonding area is achieved. If a splicing tape is misaligned, too little of the tape area will be bonded to one web relative to the other, which can lead to splice failure. In some embodiments, the alignment indicium can facilitate balancing of the splice such that there is equal shear strength between the overlapping splicing tape and each of the two joined web ends.

When bonding one end of a web to a second end of the same web, or when bonding a first end of a first web of a given material to a second end of a second web of the same material, it may be desirable to position the splicing tape relative to the splice boundary such that the area of tape to web bonding is equal for both the first and second web ends. When bonding a first end of a first web of a given material to a second end of a second web of a different material, it may be desirable to position the splicing tape relative to the splice boundary such that the area of tape to web bonding is greater for the first web end than the second web end. For example, if the adhesion force of the splicing tape adhesive to the first web is less than the adhesion force to the second web, it may be desirable to position the splicing tape such that the bonded area of the splicing tape to the first web is greater than the bonded area of the second web.

Referring to FIG. 6A, splicing tape 600, according to some embodiments of the present invention, includes alignment indicium 610, which is a single, continuous, straight line with major axis 615. Major axis 615 of alignment indicium 610 is substantially parallel to and offset by distance D from centerline 605 of splicing tape 600.

Splice boundary 620, having splice major axis 625, is formed by the junction of first web end 621 and second web end 622. Alignment indicium 610 is positioned relative to splice boundary 620 so that major axis 615 of alignment indicium 610 is aligned with splice major axis 625, e.g., major axis 615 of alignment indicium 610 substantially overlays splice major axis 625.

As shown in FIG. 6B, by adhering splicing tape 600 to web ends 621 and 622, a splice will be formed with first bonded area 631 and second bonded area 632. First bonded area corresponds to the area of contact between splicing tape 600 and first web end 621, while second bonded 632 area corresponds to the area of contract between splicing tape 600 and second web end 622. In some embodiments, the use of some splicing tapes of the present invention facilitates the simple, precise and accurate positioning of the splicing tape relative to the splice boundary such that the desired ratio of first bonded area 631 to second bonded area 632 may be achieved.

Referring to FIG. 7, splicing tape 700, according to some embodiments of the present invention, includes alignment indicium 710, which is a single, discontinuous undulating line. Major axis 715 of alignment indicium 710 is substantially parallel to and aligned with centerline 705 of splicing tape 700.

Undulating splice boundary 720, having splice major axis 725, is formed by the junction of first web end 721 and second web end 722. Splice major axis 725 forms angle X relative to reference line 730, which is perpendicular to the centerline of the web. Alignment indicium 710 is positioned relative to splice boundary 720 so that major axis 715 of alignment indicium 710 is aligned with, and substantially overlaps splice major axis 725. In some embodiments, such alignment will result in undulating alignment indicium 710 substantially overlapping undulating splice boundary 720. In some embodiments, the use of some splicing tapes of the present invention facilitates the simple, precise and accurate positioning of the splicing tape relative to an undulating splice boundary. In some embodiments, the use of some splicing tapes of the present invention facilitates the simple, precise and accurate positioning of the splicing tape relative to an angled splice boundary.

Referring to FIG. 8, splicing tape 800, according to some embodiments of the present invention, includes an alignment indicium comprising first array of symbols 811 and second array of symbols 812. First major axis 821 of first array of symbols 811 and second major axis 822 of second array of symbols 821 are substantially parallel to and offset from centerline 805 of splicing tape 800. In some embodiments, first array of symbols 811 are aligned with undulating splice boundary 830, such that first major axis 821 is tangent to peaks 831 of undulating splice boundary 830. In some embodiments, second array of symbols 812 are aligned with undulating splice boundary 830, such that second major axis 822 is tangent to valleys 832 of undulating splice boundary 830. In some embodiments, the use of some splicing tapes of the present invention facilitates the simple, precise and accurate positioning of a splicing tape relative to an undulating splice boundary.

In some embodiments, it is desirable to align a splicing tape containing reinforcement fibers relative to the webs such that the fibers are parallel to the length dimension of the web. When the splice boundary is formed at an angle relative to the width of the webs, this may require a splicing tape having angled reinforcing fibers. For example, referring to FIGS. 9A and 9B, splicing tape 900 comprises reinforcing fibers 940 that are substantially co-aligned at an angle Y relative to a reference line that is perpendicular to centerline 905 of tape 900. Splicing tape 900 includes an alignment indicium, i.e., line 910. Major axis 911 of the alignment indicium is parallel to and substantially aligned with centerline 905.

Major axis 920 of splice boundary 915 forms angle X relative to reference line 901, which is perpendicular to web centerline 935. Thus, by appropriate selection of a splicing tape such that angle Y is substantially equal to angle X, when splicing tape 900 is applied to web ends 921 and 922 such that major axis 911 of the alignment indicium is substantially aligned with major axis 920 of splice boundary 915, reinforcing fibers 940 will be substantially aligned with web centerline 935. In some embodiments, the difference between angle Y (i.e., the angle of the reinforcing fibers) and angle X (i.e., the angle of the splice boundary) differ by less than about 10°; in some embodiments, the difference between angles Y and X is less than about 5°; in some embodiments, less than about 3°, or even less than about 1°. In some embodiments, the present invention facilitates the simple, precise and accurate positioning of splicing tapes comprising reinforcement fibers relative to a splice boundary; in some embodiments, an angled splice boundary. In some embodiments, the present invention facilitates the alignment of reinforcement fibers in a splicing tape relative to the centerline of a web.

Various modifications and alterations of this invention will become apparent to those skilled in the art without departing from the scope and spirit of this invention.

What is claimed is:

1. A splicing tape comprising:
a backing having a first major surface, a second major surface, and a centerline;
an adhesive adjacent the first major surface of the backing; and
an alignment indicium visible from the second major surface of the backing;
wherein the alignment indicium has a major axis parallel to the centerline of the tape.

2. The splicing tape of claim 1, wherein the splicing tape is transparent.

3. The splicing tape of claim 1, wherein the alignment indicium is adjacent the second major surface of the backing.

4. The splicing tape of claim 1, wherein the alignment indicium is interposed between the first major surface of the backing and the adhesive.

5. The splicing tape of claim 1, wherein the alignment indicium is adjacent a surface of the adhesive opposite the first major surface of the backing.

6. The splicing tape of claim 1, wherein the alignment indicium comprises a first line.

7. The splicing tape of claim 6, wherein the first line is a continuous line.

8. The splicing tape of claim 6, wherein the first line is a discontinuous line.

9. The splicing tape of claim 6, wherein the first line is parallel to and substantially aligned with the centerline of the tape.

10. The splicing tape of claim 6, wherein the first line is parallel to and offset from the centerline of the tape.

11. The splicing tape of claim 6, wherein the first line is an undulating line.

12. The splicing tape of claim 11, wherein at least one of a line tangent to the peaks of the undulating line and a line tangent to the valleys of the undulating line is parallel to the centerline of the tape.

13. The splicing tape of claim 11, wherein the undulating line is a sinusoidal line.

14. The splicing tape of claim 11, wherein the undulating line is a saw-toothed line.

15. The splicing tape of claim 6, further comprising a second line, wherein the first line and the second line are parallel to the centerline of the tape.

16. The splicing tape of claim 1, wherein the alignment indicium comprises an array of symbols.

17. The splicing tape of claim 16, wherein the gap between adjacent symbols is less than about 25 millimeters.

18. A method of splicing two web ends comprising:
(a) placing a first end of a first web in alignment with a second end of a second web forming a splice boundary having a splice major axis;
(b) aligning the major axis of the alignment indicium of the splicing tape of claim 1 with the splice major axis; and
(c) adhering the splicing tape to the first web and the second web.

19. The method of claim 18, wherein the first web and the second web are the same web.

20. The method of claim 18, wherein (b) comprises substantially overlapping the splice major axis with the major axis of the alignment indicium.

21. The method of claim 18, wherein the splice boundary comprises an undulating boundary comprising a plurality of peaks and a plurality of valleys.

22. The method of claim 21, wherein the alignment indicium comprises an undulating line and wherein (b) comprises substantially aligning the undulating line of the alignment indicium with the undulating splice boundary.

23. The method of claim 21, wherein the alignment indicium comprises a first line and a second line, wherein the first line and the second line are parallel to the centerline of the tape, and wherein (b) comprises substantially aligning the first line with the peaks of the undulating splice boundary.

24. The method of claim 18, wherein the alignment indicium comprises a first line and a second line, wherein the first line and the second line are parallel to the centerline of the tape, and wherein (b) comprises aligning the splice boundary between the first line and the second line.

25. A spliced web wherein a first end of a first web and a second end of a second web are adhered to the tape of claim 1.

26. The spliced web of claim 25, wherein the first web and the second web are the same web.

27. The spliced web of claim 25, wherein the first web is an abrasive article.
